(19) United States
(12) Patent Application Publication
(10) Pub. No.: US 2010/0269613 A1
(43) Pub. Date: Oct. 28, 2010

(54) MULTI-CLUTCH TRANSMISSION HAVING DUAL FRONT-POSITIONED GEARS AND METHOD OF OPERATING THE SAME

(76) Inventor: Myungkoo KANG, Busan (KR)

Correspondence Address: BIRCH STEWART KOLASCH & BIRCH, PO BOX 747, FALLS CHURCH, VA, 22040-0747, US

(21) Appl. No.: 12/766,306

(22) Filed: Apr. 23, 2010

(30) Foreign Application Priority Data
Apr. 24, 2009 (KR) 10-2009-0035890

(51) Int. Cl. F16H 3/16

(52) U.S. Cl. 74/331

(57) ABSTRACT

A multi-clutch transmission having dual front-positioned gears and a method of operating the same are provided. Compared to a known dual clutch transmission, the multi-clutch transmission provides a simple structure, stable operation, and easy manufacturing and maintenance. The multi-clutch transmission includes an input shaft connected to a flywheel, first and second layshafts receiving rotating power from the input shaft, first and second front-positioned gears installed at respective front ends of the first and second layshafts, first and second clutches installed on the first and second layshafts in the rear of the first and second front-positioned gears respectively, first and second rotating-direction correction gears installed on the first or second layshaft in order to rotate the first and second layshafts in the same direction, and an output shaft interposed between the first and second layshafts and disposed parallel to each of the first and second layshafts.

### BACKGROUND OF THE INVENTION

1. Field of the Invention

The present invention generally relates to a multi-clutch transmission, and more particularly to a multi-clutch transmission having dual front-positioned gears in a vehicle, in which two front-positioned gears are disposed at the front of two parallel lay-shafts, and two or three clutches are power-connected to the front-positioned gears, thereby reducing the minimum necessary size of clutches to remove size discrepancy between the width of the gearbox and the sum of diameters of the clutches, thereby reducing a volume of the gearbox to optimize an engine room and improve fuel efficiency.

2. Description of the Prior Art

A dual clutch transmission refers to a transmission that is designed to dispose two clutches at the front thereof so as to continue to be selectively operated, thereby remarkably reducing the speed change time. This dual clutch transmission is a well developed type of automated manual transmission, and has recently gotten into the spotlight due to low power loss, high efficiency, rapid speed change, and sporty driving style, together with the manual transmission being highly economical. A typical example in which the dual clutch transmission is used in mass-produced vehicles is a direct shift gearbox (DSG) adopted by Volkswagen AG. This DSG of Volkswagen AG is designed to remarkably reduce the time required to change speeds by allowing a first input shaft to be coaxially rotated within a second input shaft having a hollow funnel shape, and connecting first and second wet multi-disc clutches to the respective first and second input shafts, and selectively engaging or releasing each clutch. This coaxial DSG, in which the two input shafts have the same center, has a complicated structure, an expensive production cost, and a different type of maintenance.

FIGS. 1 and 2 are conceptual views of a known dual clutch transmission, which is disclosed in Japanese Published Patent Application No. H10 (1998)-26189, titled “Underload Transmission Gear Unit with Double Clutch for Agricultural Tractor with or without Drive Clutch.” This transmission is designed to dispose two driving shafts 14a and 14b in parallel so as to be spaced apart from each other and dispose three gear wheels 2, 3a and 3b at the front of the driving shafts so as to be engaged with each other, and is mainly applied to agricultural tractors, which serve to do farm work requiring high torque while being driven at low speed rather than at high speed.

Typically, vehicles start with the first speed gear in a stopped state. At this time, the load of the vehicle is transmitted to the wheels, and the force of friction is exerted in a direction opposite to the forward direction due to friction between the wheels and the ground. For the frictional force, it is to be noted that a static frictional force is greater than a kinetic frictional force, and thus the maximum frictional force is exerted when a vehicle undergoes the speed change to the first speed. Thus, the clutch engaged with a first speed gear must have a large size, and also the clutch has a minimum size required to overcome this static friction force. Since the agricultural tractor of Japanese Published Patent Application No. H10 (1998)-26189 has a structure suitable for farm work requiring high torque while being driven at low speeds rather than at high speeds, there is a big difference in its purpose and structure compared to the transmission for a vehicle. In the case in which the gear ratio of the first speed gear of the vehicle typically has a range from about 1:3 to about 1:4, the gear ratio of the first speed gear of the tractor is much greater than that of the vehicle, so that the tractor may have a relatively small clutch size and must have a much greater gear size in the gearbox compared to the vehicle. Unlike vehicles, tractors must exert high torque using a small engine of small horsepower, and aims at dealing well with the high torque at low speed without requiring high-speed rotation. Typically, tractors are driven at an engine speed of 500 to 1000 rpm and at a wheel speed of 10 to 250 rpm. Thus, the transmission of the tractor is a sort of deceleration transmission unlike that of a vehicle. In view of characteristics of the transmission of the tractor, the engine and clutch undergo a low load. As such, the tractor may have a small clutch, and be driven in normal engagement without a clutch according to circumstances. By contrast, in the case of vehicles, the gear ratio is 1:4 for the first speed, 1:1 for the fourth speed, and 0.7:1 for the sixth speed. Thus, the transmission of the vehicle functions as a deceleration transmission on a low-speed region, and an acceleration transmission on a high-speed region. Due to the characteristic differences between a vehicle and a tractor with regard to purpose, function and structure, a factor determining the size of the gearbox of the tractor is not the clutch size but the gear size in the gearbox. However, in the case of dual clutch type vehicles in which two layshafts are disposed in parallel, the size of the gearbox is determined by the minimum necessary size of the clutches.

Further, in the case of the tractors, since they are larger than vehicles, serious trouble is not expected even when the gearbox size is increased due to an increase in the size of the gears in the transmission. However, in the case of vehicles, it is very important to design the gearbox to be as small as possible. Otherwise, the engine room runs short of allowances for its design and modification, and it is impossible to contribute to improving the fuel efficiency by reducing the weight of the vehicle. Taking into consideration the present situation of the motor vehicle industry that makes every effort to improve the fuel efficiency of the vehicle due to an increase in oil prices, it is natural to attempt to reduce the size of the gearbox.

Thus, it is very necessary to develop a new dual clutch transmission having a structure that can be efficiently applied to passenger cars without increasing the gearbox size by solving the discrepancy between the minimum necessary clutch size and the gearbox size.

### SUMMARY OF THE INVENTION

Accordingly, the present invention has been made keeping in mind the above problems occurring in the prior art, and an object of the present invention is to provide a dual or triple clutch transmission for a vehicle, which is excellent in power transfer efficiency, is not complicated in construction, is inexpensive in terms of production and maintenance expenses, has a simple design of a gear ratio, and is improved so as to adjust a minimum necessary size of clutches to minimize its volume.

Another object of the present invention is to provide a method of operating a multi-clutch transmission having dual front-positioned gears, capable of efficiently operating a main clutch disposed on an inner front side thereof and rear first and second clutches disposed on an inner rear side thereof to carry out a change of speed.

According to one aspect of the present invention, there is provided a multi-clutch transmission having dual front-positioned gears, which converts and outputs rotating power transmitted from an engine. The multi-clutch transmission comprises: an input shaft connected to a flywheel and receiving the rotating power from the engine; first and second layshafts receiving the rotating power from the input shaft and disposed parallel to and apart from each other; first and second front-positioned gears, the first front-positioned gear installed at a front end of the first layshaft and power-connected with the input shaft, and the second front-positioned gear installed at a front end of the second layshaft and engaged with the first front-positioned gear; first and second clutches, the first clutch installed on the first layshaft in the rear of the first front-positioned gear, and the second clutch installed on the second layshaft in the rear of the second front-positioned gear; first and second rotating-direction correction gears which are installed on one of the first and second layshafts in order to rotate the first and second layshafts in the same direction and are engaged with each other; and an output shaft interposed between the first and second layshafts and disposed parallel to each of the first and second layshafts.

In exemplary embodiments, the first clutch may have a diameter greater than that of the second clutch. The first and second clutches may be disposed on different planes in an offset fashion. An outer circumference of the first clutch may overlap with that of the second clutch by a predetermined range.

In exemplary embodiments, the input shaft may have a main clutch, a diameter of which is greater than those of the first and second clutches, between the flywheel and the first front-positioned gear.

In exemplary embodiments, the first and second clutches may be disposed on different planes in an offset fashion, and an outer circumference of the first clutch may overlap with that of the second clutch by a predetermined range.

According to another aspect of the present invention, there is provided a method of operating a multi-clutch transmission having dual front-positioned gears, in which a main clutch is installed on an input shaft power-connected to a flywheel, and first and second clutches are installed on two parallel layshafts power-connected to the input shaft. The method comprises: a) in a first speed mode in which a vehicle starts with a first speed gear in a stopped state, previously engaging the first clutch, disengaging the second clutch, and engaging the main clutch in a disengaged state to transmit rotating power to a first speed gear; b) in variable-speed modes following a second speed mode, continuing to engage the main clutch, and alternately engaging the first or second clutch to transmit the rotating power to respective variable-speed gears; and c) in reverse mode in which the vehicle is reversed in the stop state, previously engaging the second clutch, disengaging the first clutch, and engaging the main clutch in a disengaged state to transmit the rotating power to a reverse gear.

According to exemplary embodiments, the multi-clutch transmission allows for easy production and maintenance due to its simple construction, and has excellent durability due to infrequent breakdowns. Further, the multi-clutch transmission can satisfy the necessary torque requirements and flexibly adjust the minimum necessary size of clutches, so that it can prevent an increase in its size caused by an increase in the size of the clutch, and optimize its size. As a result, it is easy to design and modify the structure of an engine room.

In addition, the multi-clutch transmission employs a triple clutch structure to be able to be applied to large-sized vehicles requiring high torque such as buses or trucks mainly using a dry clutch without increasing its volume, so that its application is very wide. This is expected to be able to solve the problem of known dual clutch transmissions being mainly applied only to sport sedans.

### BRIEF DESCRIPTION OF THE DRAWINGS

The above and other objects, features and other advantages of the present invention will be more clearly understood from the following detailed description when taken in conjunction with the accompanying drawings, in which:

FIGS. 1 and 2 are conceptual views of a known dual clutch transmission;

FIG. 3 schematically illustrates construction of a dual clutch transmission according to a first exemplary embodiment of the present invention;

FIG. 4 schematically illustrates construction of a dual clutch transmission according to a second exemplary embodiment of the present invention;

FIG. 5 schematically illustrates construction of a triple clutch transmission according to a third exemplary embodiment of the present invention;

FIG. 6 schematically illustrates construction of a triple clutch transmission according to a fourth exemplary embodiment of the present invention; and

FIG. 7 is a conceptual view illustrating comparison between relative sizes of gearboxes or transmissions according to type.

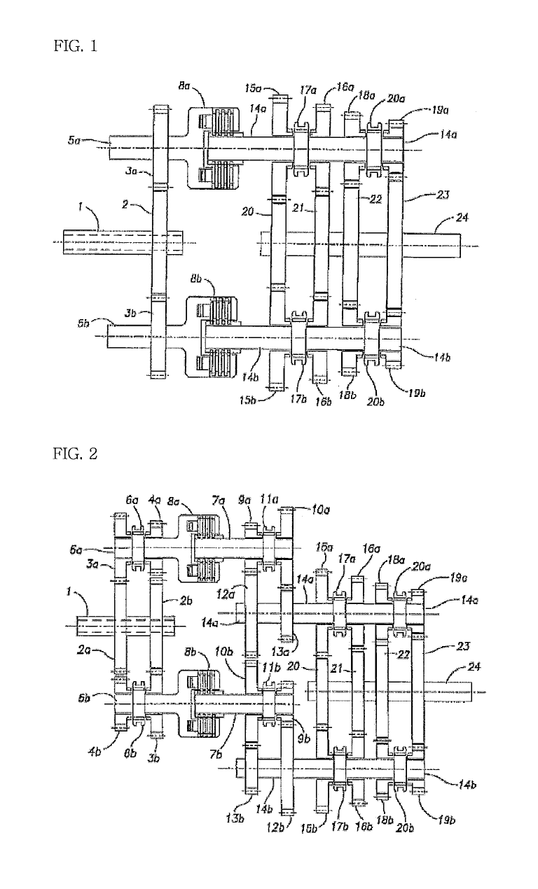

### DETAILED DESCRIPTION OF THE INVENTION

Reference will now be made in greater detail to an exemplary embodiment of the invention, an example of which is illustrated in the accompanying drawings. Wherever possible, the same reference numerals will be used throughout the drawings and the description to refer to the same or like parts.

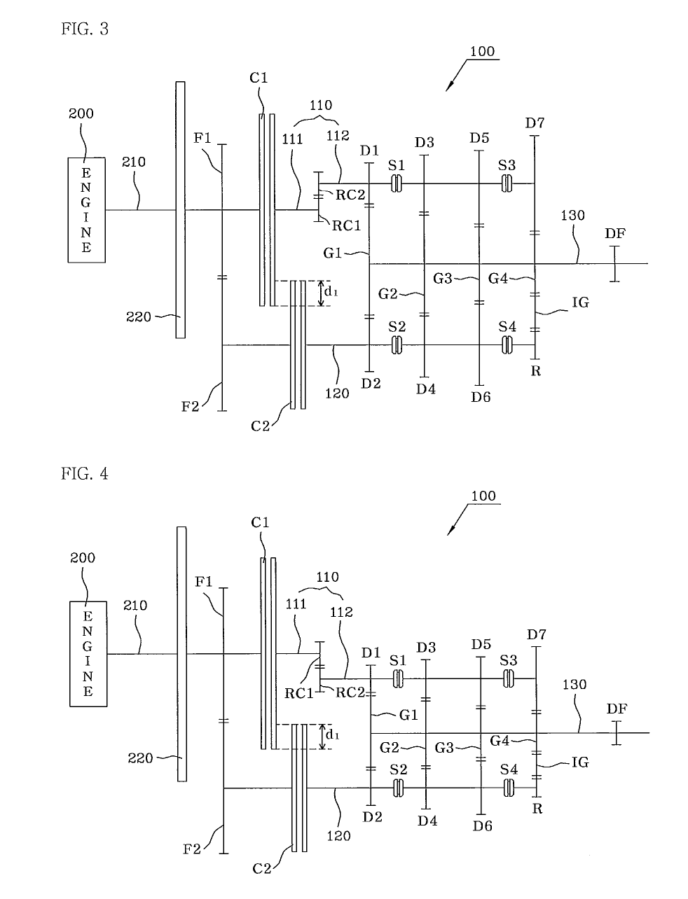

FIG. 3 schematically illustrates construction of a dual clutch transmission according to a first exemplary embodiment of the present invention. As illustrated in FIG. 3, the dual clutch transmission according to a first exemplary embodiment of the present invention basically includes two front-positioned gears F1 and F2, first and second clutches C1 and C2, two rotating-direction correction gears RC1 and RC2, two layshafts 110 and 120, and an output shaft 130.

In the present embodiment, the two front-positioned gears F1 and F2 are disposed at the rear of a flywheel 220 receiving rotating power from an engine 200. In detail, the first front-positioned gear F1 receives the rotating power from the flywheel 220 through an input shaft 210, and the second front-positioned gear F2 engages with the first front-positioned gear F1 and receives the rotating power from the first front-positioned gear F1. The first front-positioned gear F1 is connected to the first layshaft 110 and transmits the rotating power. The second front-positioned gear F2 is connected to the second layshaft 120 and transmits the rotating power. The first clutch C1 is mounted on the first layshaft 110 at the rear of the first front-positioned gear F1, and the second clutch C2 is mounted on the second layshaft 120 at the rear of the second front-positioned gear F2.

As illustrated in FIG. 3, the first layshaft 110 is divided into two parts, i.e. a front shaft 111 and a rear shaft 112. This is for rotating the first and second layshafts 110 and 120 in the same direction. In other words, the first rotating-direction correction gear RC1 is coupled to a rear end of the front shaft 111 of the first layshaft 110, and the second rotating-direction correction gear RC2 engaged with the first rotating-direction correction gear RC1 is coupled to a front end of the rear shaft 112 of the first layshaft 110.

In the illustrated embodiment, the rotating-direction correction gears RC1 and RC2 are installed on the first layshaft 110. Alternatively, the rotating-direction correction gears RC1 and RC2 may be installed on the second layshaft 120.

A plurality of variable-speed gears D1 to D7 and R acting as driving gears are sequentially disposed on the first and second layshafts 110 and 120. Synchromeshes S1 to S4 are slidably coupled to the shafts between the variable-speed gears so as to be selectively engaged with or released from the variable-speed gears to transmit or interrupt the power. The synchromeshes S1 to S4 are connected to actuators (not shown) and operated by an electronic control unit (not shown).

The output shaft 130 is located between the first and second layshafts 110 and 120, and is parallel to the first and second layshafts 110 and 120. It is not essential that the output shaft 130 be equidistant from the first and second layshafts 110 and 120. Thus, the gear ratio of the transmission may be flexibly adjusted by adjustment of the position or displacement of the output shaft 130.

A plurality of output gears G1 to G4 acting as driven gears are disposed on the output shaft 130. The output gears G1 to G4 are engaged with the even and odd variable-speed gears of the first and second layshafts 110 and 120. A symbol DF, which has not been described in the figures, indicates a differential gear.

An operation mechanism of the dual clutch transmission having the construction as described above in accordance with a first exemplary embodiment of the present invention will be described below. First, in a first speed mode (first speed gear), rotating power (i.e. engine power) is transmitted from the engine 200 to the first layshaft 110 via the input shaft 210. Here, the first clutch C1 is power-connected, whereas the second clutch C2 is power-disconnected. The first synchromesh S1 is engaged with the first speed gear D1 such that the rotating power can be transmitted to the first speed gear D1. Since the first speed gear D1 is engaged with the first output gear G1, the rotating power is transmitted to the different gear DF through the first output gear G1 acting as the driven gear and the output shaft 130. Here, the second synchromesh S2 is previously selected for the speed change to the next speed, and is engaged with the second speed gear D2, which is referred to as a pre-select state. Even when the second speed gear D2 is in the pre-selected state, the rotating power of the input shaft 210 is not transmitted to the second speed gear D2, i.e. the second speed gear D2 remains in an idle state, because the second clutch C2 connected to the second layshaft 120 is power-disconnected.

Afterwards, in a second speed mode (second speed gear), the first clutch C1 is disconnected, whereas the second clutch C2 is power-connected. Here, since the second speed gear D2 has already been pre-selected, the second speed gear D2 receives the rotating power as soon as the second clutch C2 is connected, transmits it to the first output gear G1, and rotates the output shaft 130. In this case, like the aforementioned first speed mode, the first synchromesh S1 is engaged with the third speed gear D3 for the speed change to the next speed, and enters the pre-select state. Thereby, the speed change to the next speed is prepared for.

When these processes are sequentially carried out, the variable-speed gears are continuously operated from the first speed gear (D1) to the seventh speed gear (D7) until the vehicle starts from a zero speed (i.e. stopped state) to reach a maximum speed. A symbol IG, which has not been described in the figures, indicates an idling gear for synchronizing a rotating direction of the reverse gear R.

In the present embodiment, the first and second clutches C1 and C2 have different sizes and are disposed on different planes in an offset fashion. In detail, the first clutch C1 is offset from the second clutch C2 in a horizontal direction. Since the first speed gear D1 and the reverse gear R of the variable-speed gears typically allow the vehicle to start from the stop state, a high torque is required due to a great static friction force. As such, the clutches have a minimum necessary size such that the wheels can overcome the static friction force to move without slipping. This minimum necessary clutch size increases in proportion to the size of the vehicle. In the case of buses or trucks, a high torque is required, and thus a dry clutch is used which has a diameter greater than that of a wet multi-disc clutch and produces an excellent friction effect and a low power loss. Even in the case of small-sized vehicles using such a wet multi-disc clutch, it is advantageous if the wet multi-disc clutch for connecting the first speed gear has a large size from the viewpoint of the torque. Particularly, when starting on a slope, the vehicle will require a higher torque or a larger minimum necessary clutch size for the first speed gear. For this reason, in the present embodiment, the first clutch C1 requiring a relatively high torque when the vehicle starts has a size larger than that of the second clutch C2. When the size of the first clutch C1 is increased, the volume of the gearbox is also increased. This phenomenon can be prevented by disposing the first and second clutches C1 and C2 on different planes in an offset fashion. In other words, as illustrated in the figures, when the first and second clutches C1 and C2 are disposed in an offset fashion such that an outer circumference or edge of the first clutch C1 overlaps with that of the second clutch C2 by a predetermined range d1, the width of the gearbox is reduced, so that the phenomenon of the volume of the gearbox being increased can be prevented, while the minimum necessary clutch size can be increased. Due this advantage, the construction of the dual clutch transmission of the present embodiment may be applied to small-sized vehicles as well as to medium and large-sized vehicles which require the clutch to be large in size.

FIG. 4 schematically illustrates construction of a dual clutch transmission according to a second exemplary embodiment of the present invention. The present embodiment is similar in construction to the first embodiment. However, in the first embodiment, the second rotating-direction correction gear RC2 is engaged with the first rotating-direction correction gear RC1 on an outer side of the first rotating-direction correction gear RC1. By contrast, in the present embodiment, the second rotating-direction correction gear RC2 is engaged with the first rotating-direction correction gear RC1 on a lower of the first rotating-direction correction gear RC1. Thus, the rear shaft 112 of the first layshaft 110 is located inside the front shaft 111, a distance between the first and second layshafts 110 and 120 is reduced, so that the width of the gearbox is reduced.

FIG. 5 schematically illustrates construction of a triple clutch transmission according to a third exemplary embodiment of the present invention. In the present embodiment, all three clutches are operated unlike the aforementioned embodiments. In detail, the main clutch MC is interposed between a flywheel 220 and a first front-positioned gear F1, and the first and second clutches C1 and C2 are disposed at rears of the first and second front-positioned gears F1 and F2, respectively. Further, in the present embodiment, a second layshaft 120 is divided into a front shaft 121 and a rear shaft 122, and first and second rotating-direction correction gears RC1 and RC2 are installed on the front and rear shafts 121 and 122 respectively, and are engaged with each other. Of course, in the present embodiment, the first and second rotating-direction correction gears RC1 and RC2 may be installed on the first layshaft 110. This construction is not excluded in the present invention.

In the present embodiment, the main clutch MC is larger than the two other clutches C1 and C2. As to the size order of the components, the flywheel 220, the main clutch MC, and the first and second clutches C1 and C2 are sequentially reduced in that order. An operation mechanism of the present embodiment having a triple clutch structure is slightly different from those of the aforementioned embodiments. In detail, according to the present embodiment, when the vehicle starts with a first speed gear in a stopped state, the first clutch C1 has already been connected, and the main clutch MC is connected in a disconnected state, so that rotating power is transmitted to an output shaft 130. Further, when the vehicle is put in reverse, the second clutch C2 has already been connected, and the main clutch MC is connected in a disconnected state, so that rotating power is transmitted to an output shaft 130. This construction allows wheels to easily overcome a static frictional force without the clutches slipping, because the main clutch MC having a very great diameter or area takes charge of power-connection or power-disconnection even when the vehicle starts on a slope inclined at a very steep angle, so that the operation mechanism of the triple clutch transmission is very stable. The main clutch MC may be formed smaller than the flywheel 220, and the first and second clutches C1 and C2 may be formed in much smaller size compared to those of the embodiments in which the main clutch MC is not installed. Thus, the installation of the main clutch MC rather helps reduce the volume of the gearbox. Once the vehicle starts with a first speed gear, the main clutch MC is left power-connected, only the first and second clutches C1 and C2 are alternately selected to execute a speed change. Thus, the process where the variable-speed gears are selected after the vehicle starts is the same as in the aforementioned embodiments.

In the present embodiment, even when the main clutch MC has a very large size, the volume of the gearbox is not increased. As such, the present embodiment has an advantage in that it can be easily applied to the large-sized vehicles such as buses or trucks that mainly employ a dry clutch of a very large size. Further, the main clutch MC may be combined with the first and second clutches C1 and C2 in such a manner that the main clutch MC is used as a dry clutch to be fit to exert a high torque and the first and second clutches C1 and C2 are used as wet multi-disc clutches. As the main clutch MC, one selected from a dry clutch, a wet multi-disc clutch, and a torque converter for an automatic transmission may be used.

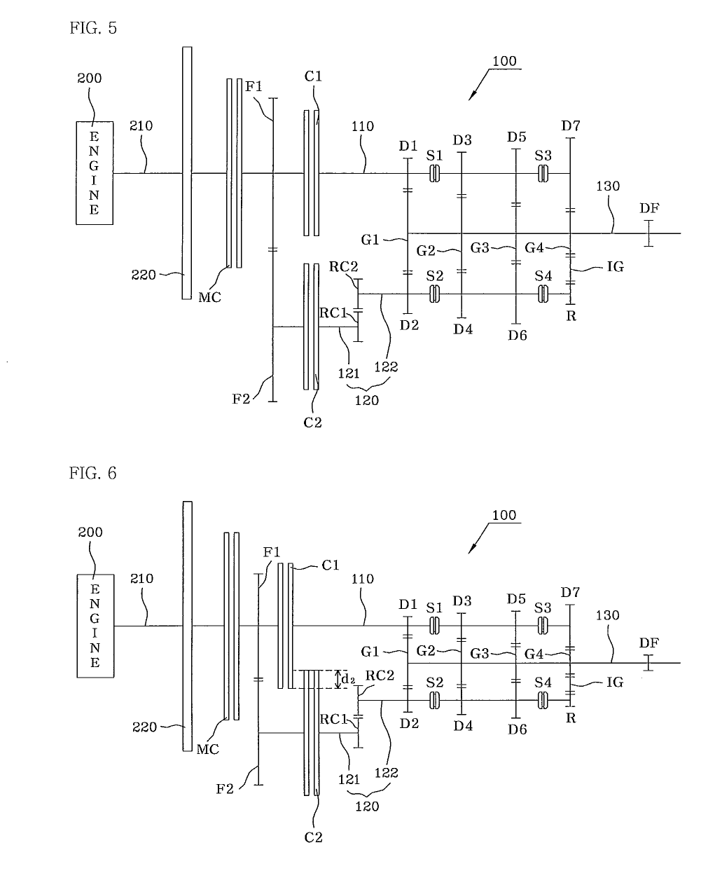

FIG. 6 schematically illustrates construction of a triple clutch transmission according to a fourth exemplary embodiment of the present invention. The present embodiment is similar in construction to the third embodiment, and is different from the third embodiment in that the first and second clutches C1 and C2 are disposed on different planes in an offset fashion. In detail, an outer circumference or edge of the first clutch C1 overlaps with that of the second clutch C2 by a predetermined range d2. Thus, the present embodiment has an advantage in that the width of the gearbox becomes smaller than that of the third embodiment.

An operation mechanism of the triple clutch transmission according to the third and fourth embodiments will be described below in detail. First, when the vehicle starts with a first speed gear D1 in a stopped state, the first clutch C1, for which a small size will do, has already been connected, and the second clutch C2 is disconnected. In this state, the gear is shifted to a first speed gear, and simultaneously the main clutch MC is engaged in a disengaged state, so that rotating power is transmitted to the first layshaft 110. Thus, the rotating power is transmitted to the output shaft 130 through the first speed gear D1.

In variable-speed modes following a second speed, the main clutch MC continues to be engaged, and only the first and second clutches C1 and C2 are alternately engaged or disengaged in the same manner as described in the first and second embodiments. Thereby, the speed change is carried out.

In reverse mode, the second clutch C2 has already been connected, and the first clutch C1 is disengaged. The gear is shifted to reverse mode, and simultaneously the main clutch MC is engaged and power-connected. Here, since only the second clutch C2 has already been connected, the rotating power of the input shaft 210 is transmitted to the second layshaft 120, so that the rotating power is transmitted to the output shaft 130 through the reverse gear R.

With this construction, when a large clutch size is required due to a great static frictional force as in the case of starting or going in reverse, the relatively large main clutch MC functions to transmit or interrupt the rotating power. Once the vehicle begins to move, the speed change is required in high-speed mode. In this case, it is possible to rapidly carry out the speed change using the first and second clutches C1 and C2, for which a relatively small size will do.

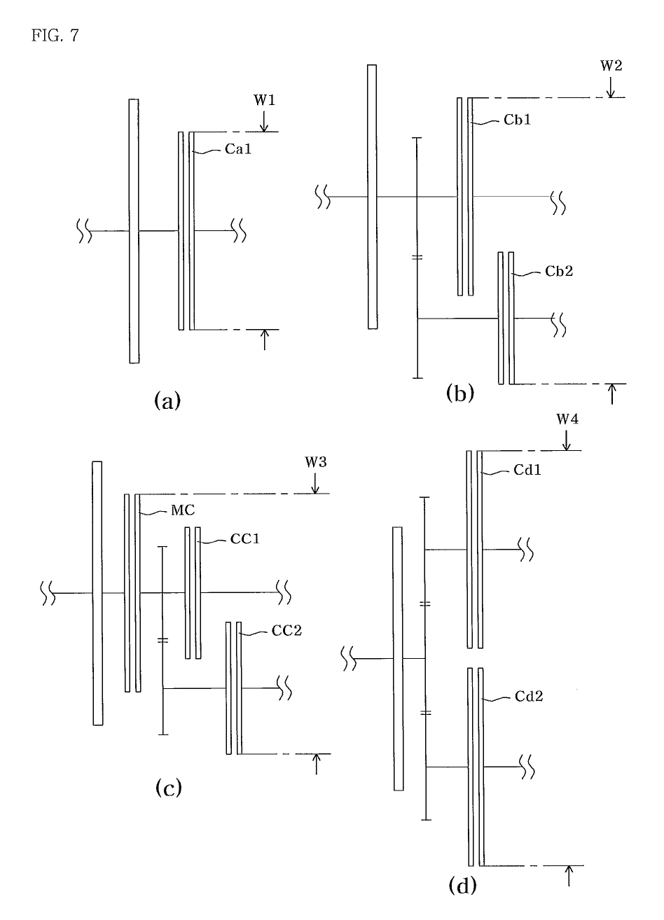

FIG. 7 is a conceptual view illustrating comparison between relative sizes of gearboxes or transmissions according to type. In FIG. 7, (a) shows a single clutch structure for a known manual transmission, (b) shows a dual clutch structure of first and second exemplary embodiments of the present invention, (c) shows a triple clutch structure of a fourth exemplary embodiment of the present invention, and (d) schematically shows a known parallel dual clutch structure. In FIG. 7, a configuration of gears at the rear of each clutch is omitted for the sake of convenience.

As illustrated, assuming that a minimum necessary size of the single clutch Ca1 of FIG. 7(a) is, for instance, 3, those of the first and second clutches Cb1 and Cb2 of FIG. 7(b) may be set to 3 and 2, respectively. In FIG. 7(c), those of the main clutch MC and the first and second clutches CC1 and CC2 may be set to 3, 2 and 3, respectively. In FIG. 7(d), those of the first and second clutches Cd1 and Cd2 may be set to 3 and 3, respectively. When arranged in turn, widths (sizes) of the gearboxes or transmissions having this construction are increased in the order of W1, W3, W2, and W4. Since the manual transmission of FIG. 7(a) has the single clutch structure, the width (size) of the transmission or gearbox is not compared with the others. When the cases of FIGS. 7(b) and 7(c) are compared with the case of FIG. 7(d), it can be found that the former are much smaller than the latter. When the size of the transmission or gearbox is reduced, this is advantageous for the design and structure modification of the engine room, the fuel efficiency, and so on.

In this manner, when the multi-clutch transmission of the present invention is applied, it is possible to effectively reduce the size of the transmission or gearbox.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A multi-clutch transmission having dual front-positioned gears, which converts and outputs rotating power transmitted from an engine, the multi-clutch transmission comprising:
an input shaft connected to a flywheel and receiving the rotating power from the engine;
first and second layshafts receiving the rotating power from the input shaft and disposed parallel to and apart from each other;
first and second front-positioned gears, the first front-positioned gear installed at a front end of the first layshaft and power-connected with the input shaft, and the second front-positioned gear installed at a front end of the second layshaft and engaged with the first front-positioned gear;
first and second clutches, the first clutch installed on the first layshaft in the rear of the first front-positioned gear, and the second clutch installed on the second layshaft in the rear of the second front-positioned gear;
first and second rotating-direction correction gears which are installed on one of the first and second layshafts in order to rotate the first and second layshafts in the same direction and are engaged with each other; and
an output shaft interposed between the first and second layshafts and disposed parallel to each of the first and second layshafts.

2. The multi-clutch transmission according to claim 1, wherein: the first clutch has a diameter greater than that of the second clutch; the first and second clutches are disposed on different planes in an offset fashion; and an outer circumference of the first clutch overlaps with that of the second clutch by a predetermined range.

3. The multi-clutch transmission according to claim 1, wherein the input shaft has a main clutch, a diameter of which is greater than those of the first and second clutches, between the flywheel and the first front-positioned gear.

4. The multi-clutch transmission according to claim 3, wherein: the first and second clutches are disposed on different planes in an offset fashion; and an outer circumference of the first clutch overlaps with that of the second clutch by a predetermined range.

5. A method of operating a multi-clutch transmission having dual front-positioned gears, in which a main clutch is installed on an input shaft power-connected to a flywheel, and first and second clutches are installed on two parallel layshafts power-connected to the input shaft, the method comprising:
a) in a first speed mode in which a vehicle starts with a first speed gear in a stopped state, previously engaging the first clutch, disengaging the second clutch, and engaging the main clutch in a disengaged state to transmit rotating power to a first speed gear;
b) in variable-speed modes following a second speed mode, continuing to engage the main clutch, and alternately engaging the first or second clutch to transmit the rotating power to respective variable-speed gears; and
c) in reverse mode in which the vehicle is reversed in the stopped state, previously engaging the second clutch, disengaging the first clutch, and engaging the main clutch in a disengaged state to transmit the rotating power to a reverse gear.
